(19) United States
(12) Patent Application Publication
(10) Pub. No.: US 2004/0083316 A1
(43) Pub. Date: Apr. 29, 2004

(54) Intelligent switching gateway

(76) Inventors: Huey-Guang Chen, Taipei (TW); Packal Su, Kaohsiung (TW)

Correspondence Address: Huey-Guang CHEN & Packal SU, P.O. Box No. 6-57, Junghe, Taipei, 235, TW

(21) Appl. No.: 10/407,228

(22) Filed: Apr. 7, 2003

(30) Foreign Application Priority Data
Oct. 25, 2002 (TW) 091124857

(51) Int. Cl. G06F 3/00

(52) U.S. Cl. 710/15

(57) ABSTRACT

The invention discloses an intelligent switching gateway for monitoring networks and the connected peripheral thereof, made up by a system structure consisted of a series of procedures including connection, inspection, check, filter, conversion and conditional filter. The system structure is connected to the communication ports of each of the connected peripherals thereof by inputting electronic signals, and is used for scanning whether each of the connected peripherals to the system is connected or off-line, and whether the signals thereof are normal or abnormal. An abnormal message with respect to a particular peripheral is sent to the user for abnormalities, or the system structure may be configured to be auto-decision-making for subsequent actions. The intelligent switching gateway effectively solves securities issues of various peripherals thus substantially elevating the quality and efficiency of communications thereof.

### BACKGROUND OF THE INVENTION

(a) Field of the Invention

The invention relates to an intelligent switching gateway capable of effectively controlling systems and the connected peripherals thereof, such that possible securities issues during signal conversion are prevented. The invention is an innovation of communications, household appliances and computer peripherals for elevating techniques and quality of electronic equipment.

(b) Description of the Prior Art

Although the new generation communication systems that achieve signal switching provide various communication peripherals with faster and more convenient information and data exchange by means of digitalization, computerization and networking, security loopholes are nevertheless found within the same network systems Hence the systems thereof tend to lead to invasions of exterior signals, resulting in system malfunctions or even complete destruction of the networks; such circumstances are not uncommon in the communication networks nowadays. In addition, various linking peripherals of communications often conclude to unsmooth communication operations due to all kinds of external reasons such as varieties of signal exchange interfaces and mistakes occurred during network installations. The difficulties in the communication operations above are not easily detected, thus frequently causing decreases in communication quality and efficiency.

When linking up all current peripherals to the server thereof for communication, or when expansion of one of the peripherals is needed, it is necessary to go through the server thereof, or to add one more interface card to complete the process, further complicating the connections and lines thereof and thus making the operations difficult Moreover, linking to networks may also incur invasions and virus infections. Firewalls and anti-virus programs are most common mechanisms against undesired invasions and virus infections at the present time. Signals at all communication ports are controlled and files are scanned in the hope of preventing unauthorized data access among the communication networks thereof and thus prohibiting probable damages. However, many evident and conceivable defectives and inconveniences yet exist in such prior safeguarding mechanisms, for instance, same security protections cannot be applied to all communication peripherals that may be infinitely expanded and cannot attend to all requirements of every communication peripheral on networks attributable to diversities with respect to functions and operations of every communication peripheral. Therefore, the prior safeguarding mechanisms are not entirely perfect and practicable.

### SUMMARY OF THE INVENTION

The object of the invention is to provide a new application for solving all the aforementioned difficulties.

To be more specific, the object of the invention is to provide an intelligent switching gateway comprising a system structure made up by a series of steps of connection inspection, check, filter, conditional filter, such that the system structure has inspecting and filtering functions as well as being capable of signal exchanging, conversion and directing through namely RJ-11, IR, USB, AV and S terminals. The system structure also links all the communication ports of every communication peripheral involved in the network in order to scan and detect the connection status of every communication peripheral within in the network thereof, and to further scan and detect whether the output/input signals of the connected peripherals are normal.

In accordance with the invention, the intelligent switching gateway exchanges, links or expands electronic signal switching equipment having a number of output/input communication port interfaces using standard electronic auto-detection output/input communication port interfaces. The system is able to scan and detect the connection status of the peripherals thereof, and also to further scan and detect whether abnormal signals are mixed among the output/input signals of the connected peripherals and then output automatically. The system, when abnormal signals are detected, outputs a signal to the user or can be configured to be auto-decision-making, or notifies the name and specification of the connected peripheral, or even enters the connected computer system to output the operation status of the hardware information (specification) and application software thereof to an assigned computer system through via network.

The invention described above is multi-functional for solving the security and virus issues that present network-related equipment, personal computer, game devices, wireless cellular phones, personal digital assistants (PDA), signal computer and switching systems are faced with, and thus providing possibilities of simplifying computer peripheral wires and expanding communication peripherals.

Where necessary, another intelligent switching gateway is added to expand the number of the output/input communication ports thereof. The Internet then adopted for manipulating far-end detection, scanning, conversion, configuration and expansion by means of the Internet connection as an interface.

### BRIEF DESCRIPTION OF THE DRAWINGS

FIG. 1 shows a block diagram of an embodiment of the intelligent switching gateway in practice in accordance with the invention.

FIG. 2 shows a flow chart of the system structure in accordance with the invention illustrating the operations thereof.

FIG. 3 shows a flow chart illustrating the check step in accordance with the invention.

FIG. 4 shows a flow chart illustrating the filter step in accordance with the invention.

FIG. 5 shows a flow chart illustrating the conditional filter step in accordance with the invention.

FIG. 6 shows a flow chart illustrating the directing step in accordance with the invention.

FIG. 7 shows a block diagram of the second embodiment illustrating the intelligent switching gateway in accordance with the invention.

FIG. 8 shows a block diagram of the third embodiment illustrating the intelligent switching gateway in accordance with the invention.

### DESCRIPTION OF THE PREFERRED EMBODIMENTS

To better understand the specific technical features and contents of the invention, detailed descriptions shall be given with the accompanying drawings hereunder

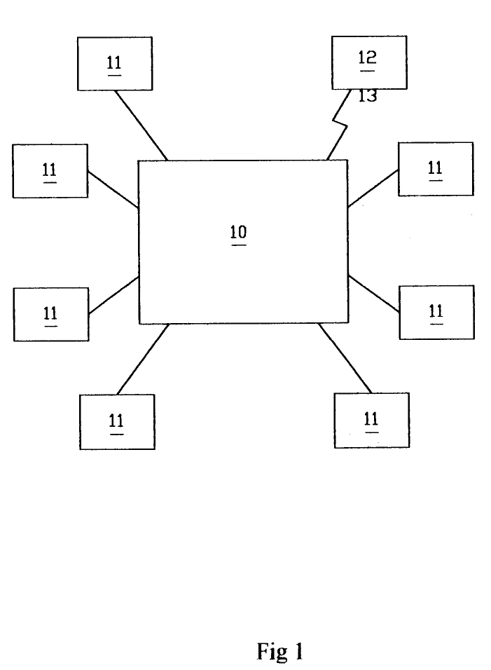

FIG. 1 shows a block diagram of an intelligent switching gateway 10 of the embodiment according to the invention.

Referring to FIG. 1, the intelligent switching gateway 10 according to a invention monitors a communication network and the peripherals 11 and 12 thereof for preventing possible security problems during signal conversions.

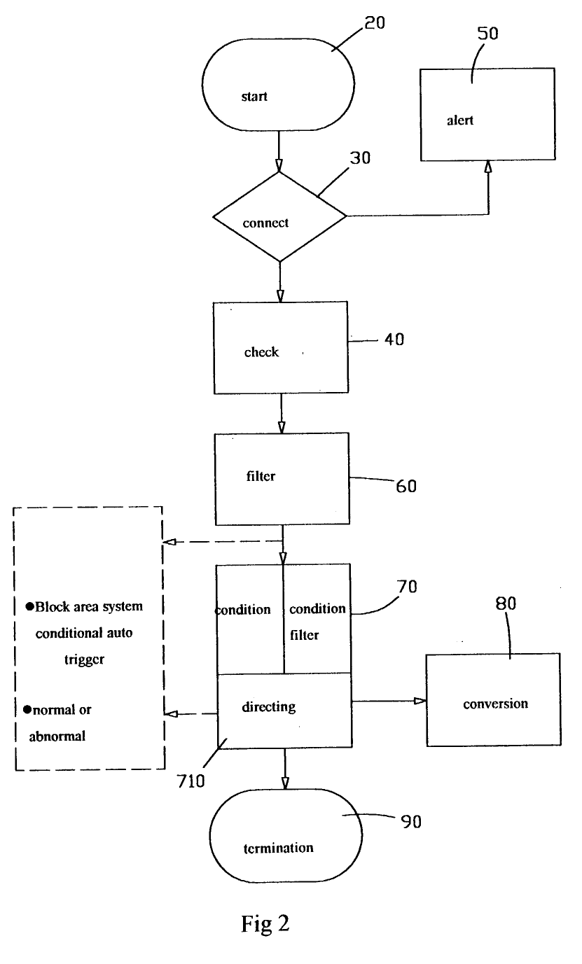

FIG. 2 shows a system block diagram of the intelligent switching gateway 10 according to the invention. The system is a system structure made up by steps of start 20, connection 30, check 40, filter 60, conditional filter 70, conversion 80, and termination 90.

The above intelligent switching gateway 10, wherein:

Step 1: start 20

The step means the power on of the system power supply, and the switch on of the connector.

The operation status includes:

normal; and

abnormal (damage or breakdown).

Step 2: connection 30

The step means the system power supply is powered on with normal operation status. The procedure of connection includes:

a. secure contact;

b. pin alignment correct;

c. standard communication protocol signals;

d. signals being sent;

e. connection;

signal wire connection

connected peripheral status—on

connected peripheral status—off

connected peripheral status—off—damaged

connected peripheral status—off—no power

connected peripheral status—off— not connected

f. registry.

Referring to FIG. 2, the following check step 40 is proceeded if all operations in the connection step 30 above are normal (yes), or an alert signal 50 shall be provided by the system if any of the operations is abnormal (no).

The relationship between the above connection step 30 and the following check step 40, that is, the relationship between “registry” and “check”, means:

quantity →

serial number (coding, forward and reverse numbering)→

registry.

Step 3: check 40:

The check step 40 comprises the operations of:

a. communication protocols (standard specifications) namely RJ-11, IR, RJ-45, USB, AV and S terminals;

b. provision of configuration checklist by interactive operation configuration;

c. mapping of signals from the input port thereof to the output port thereof according to the configuration;

d. correct registry of the final configuration

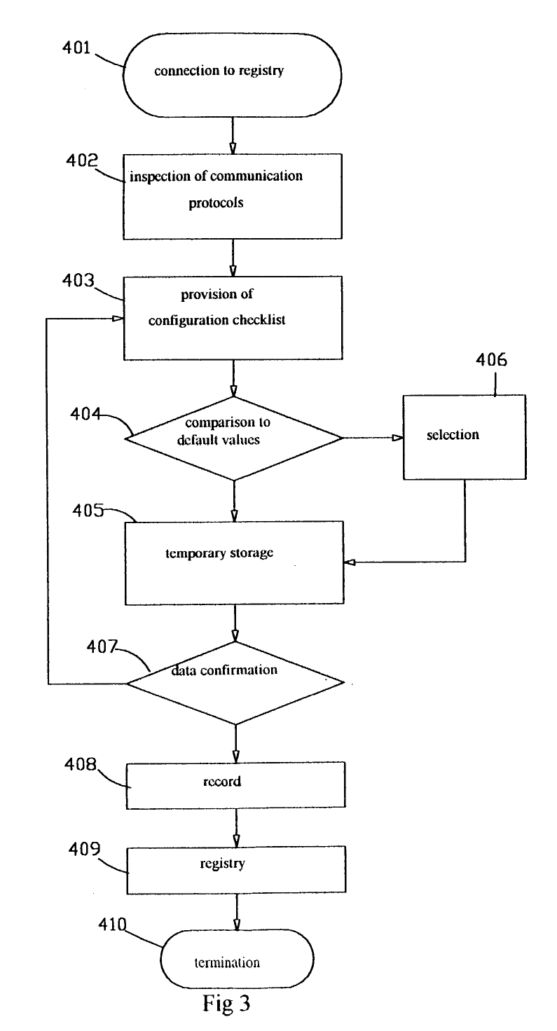

The operation flow of the check step 40 is shown in FIG. 3 as:

a. 401 connection to registry;

b. 402 inspection of communication protocols;

c. 403 provision of configuration checklist;

d. 404 comparison to default values;

if yes, forwarded to register for temporary storage 405; or

if no, forwarded to register for temporary storage 405 after selection 406;

e. 407 data confirmation;

if no, back to checklist 403 for re-comparison 404; or

if yes, forwarded through to record 408;

f. 409 registry; and

g. 410 termination.

Step 4: filter 60

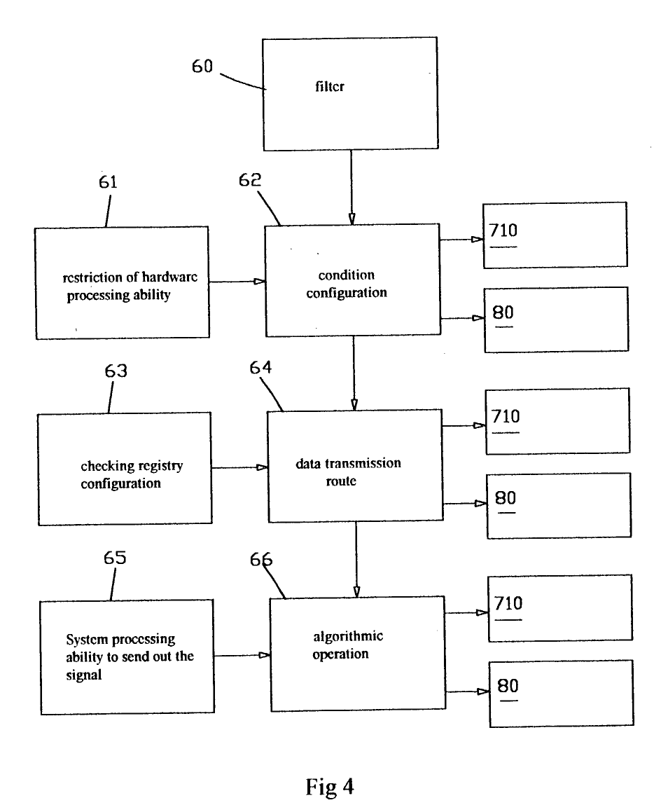

The operation flow of the filter step 60 is shown in FIG. 4, comprising:

a. restriction of hardware processing ability 61→condition configuration 62→and forwarded to directing 710 or/and conversion 80;

b. checking registry configuration 63→data transmission route →and forwarded to directing 710 or/and conversion 80; and

c. system processing ability to send out the signal 65 algorithmic operation 66>and forwarded to directing 710 or/and conversion 80.

Step 5: conditional filter 70

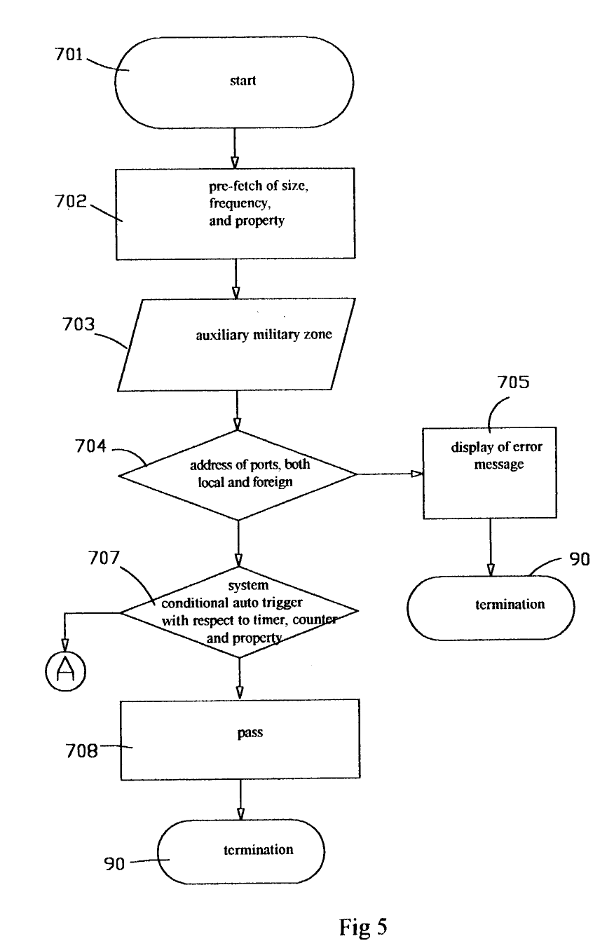

The operation flow of the conditional filter step 70 is shown in FIG. 5, comprising:

a. 701 start;

b. 702 pre-fetch of size, frequency, and property;

c. 703 auxiliary military zone;

d. 704 address of ports, both local and foreign;

if yes, forwarded to the next procedure 707, or

if no, display of error message 705 and termination 90;

e. 707 system auto trigger with respect to timer, counter and property;

if yes, forwarded to pass 708 and termination 719; or

if no, forwarded to the next procedure of directing 710; and

f. 90 termination.

Step 6: directing 710

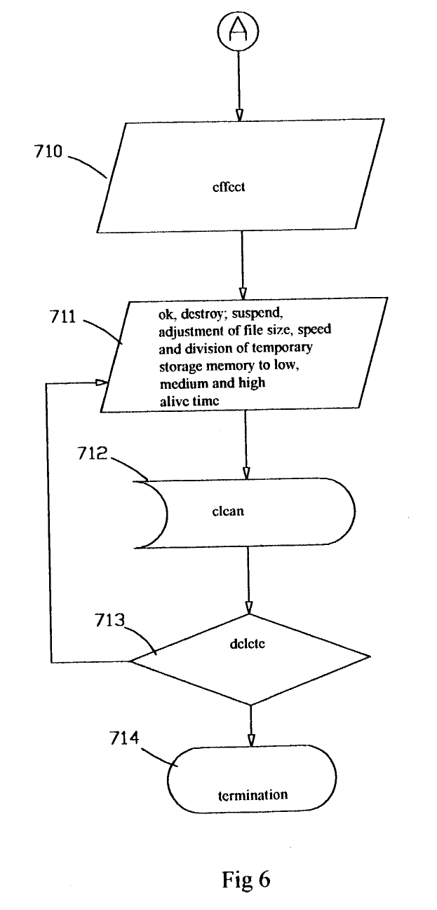

Referring to FIG. 6, this procedure continues the prior system auto trigger, 707 is if “no” and is forwarded to the procedure of directing 710, comprising:

a. 710 affect result and suspend;

b. 711 OK

destroy;

suspend;

adjustment of file size, speed and division of temporary storage memory to low, medium and high;

alive time;

c. 712 clean;

d. 713 delete?

if no, back to 711; or

if yes, termination 90.

The aforesaid intelligent switching gateway in accordance with the invention effectively monitors communication networks and the peripherals thereof, and prevents possible securities concerns during signal conversions. By means of the system structure and the operation procedures thereof, input/output signals of international standard communication protocols can be automatically detected, scanned, exchanged and expanded while having the following characteristics:

1. preventing virus infiltration and spreading, invasion of hackers, as well as cutting off pornographic signals from entering;

2. saving system resources that is usually significant wasted for checking and filtering as in current market products;

3. high utilization efficiency;

4. high security;

5. covering conversions of all existing standard input/output communication ports for easy expansion;

6. targeted at general consumers, enterprises and communication providers; suitable for ranges of wired and wireless networks, infrared and bluetooth; also suitable products such as communication information, information appliances and networks.

Referring to FIG. 1 again, the peripherals described in the embodiment of the aforesaid system in practice include wired peripheral 11 such as computer hard-disks or storage devices, home detectors, dial-up or private network equipment, game devices, keyboards, mice, AV equipment, printers, monitors, monitoring cameras, facsimile machines, scanners, electronic signal switches, as well as wireless peripherals such as PDAs and cellular phones.

Where necessary, one or more intelligent switching gateways may be added to expand the number of input/output communication ports.

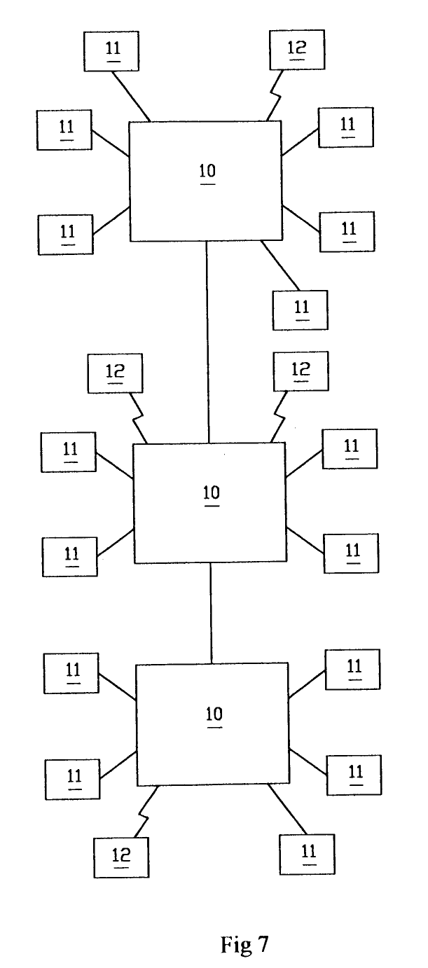

FIG. 7 shows the block diagram the third embodiment of the intelligent switching gateway according to the invention. In the embodiment, three intelligent switching gateways 10 are connected to one another, thereby substantially increasing the number of communication ports available for monitoring purposes.

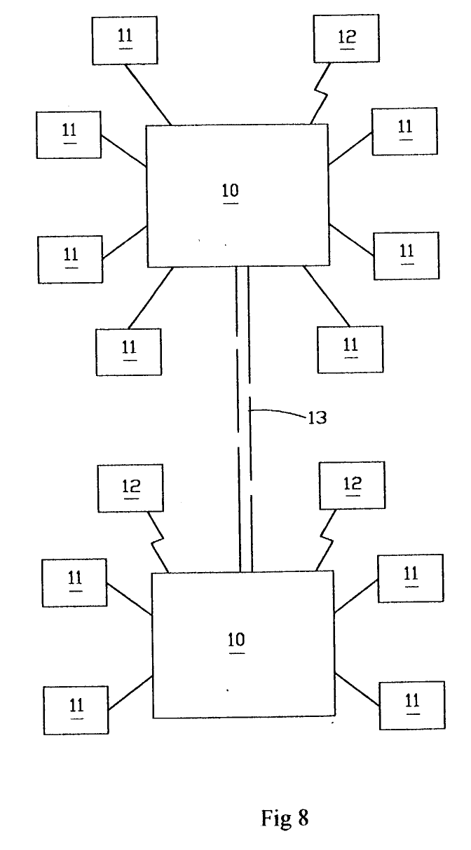

FIG. 8 shows the block diagram of the third embodiment of the intelligent switching gateway according to the invention. In the embodiment, the Internet is adopted for connecting at least two intelligent switching gateways 10 to manipulate far-end detection, scanning, conversion, configuration and expansion by means of the Internet connection as an interface 13.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. An intelligent switching gateway for monitoring systems and the connected peripheral thereof, capable of preventing possible security concerns during signal conversions, and made up by a system structure consisted of a series of procedures comprising start, connection, check, filter, conditional filter, conversion and termination, comprising:
step 1: start
the step means the power on of the system power supply, and the switch on of the connector;
the operation status includes:
normal; and
abnormal (damage or breakdown);
step 2: connection 30
the step means the system power supply is powered on with normal operation status; the procedure of connection includes:
a. secure contact;
b. pin alignment correct;
c. standard communication protocol signals;
d. signals being sent;
e. connection;
signal wire connection
connected peripheral status—on
connected peripheral status—off
connected peripheral status—off—damaged
connected peripheral status—off—not power
connected peripheral status—off—not connected
f. registry;
step 3: check 40:
the check step 40 comprises the operations of:
a. communication protocols (standard specifications) namely RJ-11, IR, RJ-45, USB, AV and S terminals;
b. provision of configuration checklist by interactive operation configuration;
c. mapping of signals from the input port thereof to the output port thereof according to the configuration;
d. correct registry of the final configuration confirmed;
the operation flow of the check step is:
a. connection to registry;
b. inspection of communication protocols;
c. provision of configuration checklist;
d. comparison to default values;
if yes, forwarded to register for temporary storage; or
if no, forwarded to register for temporary storage after selection;
e. data confirmation;
if no, back to checklist for re-comparison; or
if yes, forwarded through to record;
f. registry; and
g. termination;
step 4: filter
the operation flow of the filter step comprises:
a. restriction of hardware processing ability, condition configuration, and forwarded to directing or/and conversion;
b. checking registry configuration, data transmission route, and forwarded to directing or/and conversion; and
c. system processing ability to send the signal; algorithmic operation, and forwarded to directing or/and conversion;
step 5: conditional filter
the operation flow of the conditional filter step comprises:
a. start;
b. pre-fetch of size, frequency, and property;
c. auxiliary military zone,
d. address of ports, both local and foreign;
if yes, forwarded to the next procedure, or
if no, display of error message and termination;
e. system auto trigger with respect to timer, counter and property;
if yes, forwarded to pass and termination; or
if no, forwarded to the next procedure of directing; and
f. termination;
step 6: directing
this procedure continues the prior system auto trigger for “no” which is forwarded to this procedure of directing, comprising:
a. affect result and suspend;
b. OK
destroy;
suspend;
adjustment of file size, speed and division of temporary storage
memory to low, medium and high;
alive time;
c. clean;
d. delete?
if no, back to the previous two procedure; or
if yes, termination.

2. The intelligent switching gateway according to claim 1, wherein the connection step is proceeded to the next check step if all operations are normal (yes); or an alert message is provided by the system if any of the operations is abnormal (no).

3. The intelligent switching gateway according to claim 1, wherein relationship between the connection step and the following check step, that is, the relationship between “registry” and “check” means:
a. quantity
b. serial number (coding, forward and reverse numbering); and
c. registry.

4. The intelligent switching gateway according to claim 1, wherein the peripherals described include wired peripherals and wireless peripherals.

5. The intelligent switching gateway according to claim 1, wherein one or more intelligent switching gateways are added to expand the number of input/output communication ports thereof.

6. The intelligent switching gateway according to claims 1, wherein two or more intelligent switching gateways are connected using the Internet to manipulate far-end detection, scanning, conversion, configuration and expansion by means of the Internet connection as an interface.

7. The intelligent switching gateway according to claims 4, wherein two or more intelligent switching gateways are connected using the Internet to manipulate far-end detection, scanning, conversion, configuration and expansion by means of the Internet connection as an interface.
